(19) United States
(12) Patent Application Publication
(10) Pub. No.: US 2006/0243309 A1
(43) Pub. Date: Nov. 2, 2006

(54) Cylindrical element cleaning assemblies and related methods

(76) Inventors: James M. Prescott, Victoria, MN (US); Douglas Van Stone, Mound, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/392,983

(22) Filed: Mar. 29, 2006

Related U.S. Application Data
(60) Provisional application No. 60/666,294, filed on Mar. 29, 2005.

(51) Int. Cl. B08B 3/00; B08B 7/00

(52) U.S. Cl. 134/33; 134/34; 134/26; 134/149; 134/151; 134/137; 134/198

(57) ABSTRACT

A portable cleaning assembly for cleaning cylindrical elements such as paint roller covers and pool and spa cartridge filters. The portable cleaning includes a housing structure for fully enclosing the cylindrical element during cleaning so as to prevent overspray and subsequent clean-up of the surrounding area. The housing structure further includes a top accessible door for positioning the cylindrical element for cleaning as well as allowing visible access during a cleaning, rinsing and/or drying step without interfering with operation of the cleaning assembly. The portable cleaning assembly includes a manifold assembly including a plurality of water jet assemblies for spraying the cylindrical elements. In addition, the portable cleaning assembly includes a turbine assembly upon which the cylindrical element is mounted and spun, under the direction of the water jet assemblies, during the cleaning operation.

### PRIORITY CLAIM

The present application claims priority to U.S. Provisional Patent Application No. 60/666,294 filed Mar. 29, 2005, and entitled “FILTER CLEANING ASSEMBLY,” which is herein incorporated by reference in its entirety.

### FIELD OF THE INVENTION

The present invention relates generally to the field of cleaning assemblies. More specifically, the present invention relates to a portable cleaning assembly using a combination of rotational energy and water jet streams for cleaning cylindrical elements such as paint rollers and spa and pool filters within an enclosed assembly.

### BACKGROUND OF THE INVENTION

Removable cylindrical elements are used commonly in everyday life. For example, cylindrical elements can be configured as filters to remove contaminants from fluid streams or as paint rollers for quickly and evenly applying paint to surfaces such as walls and ceilings. In some instances, these cylindrical elements are inexpensively replaced following use. However, in other instances, these cylindrical elements have significant replacement cost. In addition, some cylindrical elements may require cleaning or rinsing during their useful life in order to function properly.

Pools and hot tubs are well known and have been used for many years in a variety of settings including residential, educational and commercial. Many pool and spa designs include water recirculation assemblies for heating, sanitizing and filtering the pool and spa water. Oftentimes, these water recirculation assemblies make use of filter cartridges for filtering particulate matter and other debris that may interfere with the proper operation of other circulation components or may reduce the enjoyment of the users. Representative cartridge filters can include filters such as, for example, pleated filters and depth filters. Representative filters can include filter media such as, for example, polymeric webs, polymeric sheets, paper sheets and other commercially available and appropriate media. Examples of representative filter cartridges include those commercially available from manufacturers such as, for example, Advantage Pool, Cal Spas®, Regal Spas, Waterworks®, as well as those available on-line through websites such as, for example, www.spadepot.com.

Many pool and spa suppliers recommend that these cartridge filters be periodically rinsed off and/or washed to increase the effectiveness and lifespan of the cartridge filter. This task of periodic rinsing and washing of the filter is considered by most consumers to be messy, difficult, time-consuming and generally less than desirable. In response to these issues, products to aid in the cleaning of spa and pool cartridge filters have been developed such as those available from Spin-N-Free, Inc., as well as the assembly described in U.S. Pat. No. 5,989,419 to Dudley et al., which is herein incorporated by reference to the extent not inconsistent with the present disclosure.

As part of their standard design, paint rollers quickly absorb and retain paint throughout their use. If the paint roller is to be reused following application of paint, the paint rollers must be quickly cleaned or rinsed before the paint hardens and the paint roller becomes unusable. Even after cleaning, the nap can become hard when left to stand and dry such that the effectiveness of the paint roller is reduced.

In order to effectively reuse the aforementioned cylindrical elements, it would be advantageous to have an easy to use cleaning device for cleaning and drying cylindrical elements that minimizes inconvenience to a user.

### SUMMARY OF THE INVENTION

The present invention is directed to a cleaning assembly having improved convenience for a user cleaning cylindrical elements such as, for example, paint rollers, pool filters and spa filters. A cleaning assembly of the present invention improves convenience for the user through a design promoting ease of use, reduction of messiness and improved drying to restore effective use of the cylindrical element. A cleaning assembly of the invention can include a housing assembly, a cylindrical element mounting assembly and a water jet assembly that cooperatively eliminate the mess and hassle typically associated with cleaning cylindrical elements. The housing assembly can include a base portion and a hinged cover for providing physical and visible access to the inside of the base portion. The cylindrical element mounting assembly can comprise a roller cage configured to accept and vertically position cylindrical elements of varying sizes on a paddlewheel assembly. The water jet assembly can include a manifold structure permanently attached to a side wall of the base portion and including at least two water jets wherein at least one water jet is adjusted to spray the cylindrical element within the roller cage and wherein at least one water jet is adjusted to spray the paddlewheel assembly to impart rotational motion to the cylindrical element mounting assembly during cleaning and drying cycles.

In one aspect, a representative cleaning assembly of the present invention can comprise a housing assembly having a base portion and a cover portion for fully enclosing a cylindrical element during cleaning and drying cycles. The cover portion is preferably pivotally attached to the base portion to allow quick physical access for install and removing cylindrical elements. In addition, the cover portion allows visible access during either the cleaning or drying cycle so as to allow a user to visually confirm that the cylindrical element is being cleaned or dried.

In another aspect, a representative cleaning assembly of the present invention can comprise a cylindrical element mounting assembly for successfully accommodating a variety of cylindrical element sizes. The cylindrical element mounting assembly can comprise a roller filter cage over which the cylindrical element is installed for cleaning and drying. The roller filter cage can permanently or releasably engage a paddlewheel assembly that interfaces with a hydraulic energy source for spinning the cylindrical mounting assembly to accelerate the cleaning and drying process.

In another aspect, a representative cleaning assembly of the present invention can comprise a water jet assembly providing both a cleaning stream and a hydraulic energy source. The water jet assembly includes a manifold assembly mounted to a side wall of a base portion that includes an inlet connection, a cleaning flow circuit and a hydraulic flow circuit wherein both the cleaning flow circuit and the hydraulic flow circuit each include at least one water jet.

In another aspect, a representative cleaning assembly of the present invention can comprise a portable cleaning assembly wherein the entire cleaning assembly can be hand-carried to a point-of-use and directly connected to water sources such as, for example, a garden hose or utility sink. Through the use of a body portion having a pivotally attached cover, cylindrical elements can be quickly installed and removed before and after cleaning. As the cylindrical elements are fully enclosed during cleaning and drying cycles, the cleaning assembly can be used indoors or out without concern for splashing water and contaminants such as particulate matter and paint on the surroundings.

In another aspect, a representative cleaning assembly of the present invention can accommodate a variety of cylindrical element sizes including varying diameters and lengths. Representative cylindrical elements can comprise paint roller covers, pool filters and spa filters. In some embodiments, a paint roller cover can be used to adapt an element mounting assembly to accept cylindrical elements having an internal diameter that exceeds a roller cage diameter on the element mounting assembly.

In another aspect, a representative cleaning assembly of the present invention can include a water jet assembly configured for use with typical residential water supplies including typical residential water flow rates and pressures. The water jet assembly can comprise at least two water jets wherein at least one jet sprays a cylindrical element while at least one jet sprays against a paddlewheel assembly. In some embodiments, each individual water jet can have its spray pattern manually configured based on the available water supply as well as the size and type of cylindrical element being cleaned.

In another aspect, a representative cleaning assembly of the present invention can include a water jet assembly having an additive reservoir providing an ability to add a filter cleaning or sanitizing solution to assist with cleaning a cylindrical element.

In another aspect, a representative cleaning assembly of the present invention can provide for cylindrical element cleaning and drying without direct supervision or intervention of a user once the cylindrical element has been operably positioned within an enclosure and a water source has been turned on.

The above summary of the various representative features of the disclosure is not intended to describe each illustrated feature or every implementation of the invention. The figures in the detailed description that follow more particularly exemplify these features.

### BRIEF DESCRIPTION OF THE DRAWINGS

The invention may be more completely understood in consideration of the following detailed description of various embodiments of the invention in connection with the accompanying drawings, in which:

FIG. 1 is a perspective, cut-away view of an embodiment of a cylindrical element cleaning assembly.

FIG. 1a is a top view of an embodiment of a cylindrical element cleaning assembly including a carrying handle.

FIG. 2 is an exploded, perspective view of an embodiment of a cylindrical element mounting assembly.

FIG. 3 is a flow diagram of an embodiment of a water jet assembly.

FIG. 4 is a flow diagram of an embodiment of a water jet assembly.

FIG. 5 is a top view of the cylindrical element cleaning assembly of FIG. 1 including an exploded view of an inlet portion of a water jet.

FIG. 6 is a perspective, cut-away view of an embodiment of a cylindrical element cleaning assembly.

FIG. 7 is an exploded, perspective view of an embodiment of a paddlewheel mounting assembly.

FIG. 8 is an exploded, perspective view of an embodiment of an engagement assembly for operably positioning a cylindrical element with respect to a paddlewheel mounting assembly.

FIG. 9 is a perspective view of an element mounting assembly adapted for use with a paint roller assembly.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

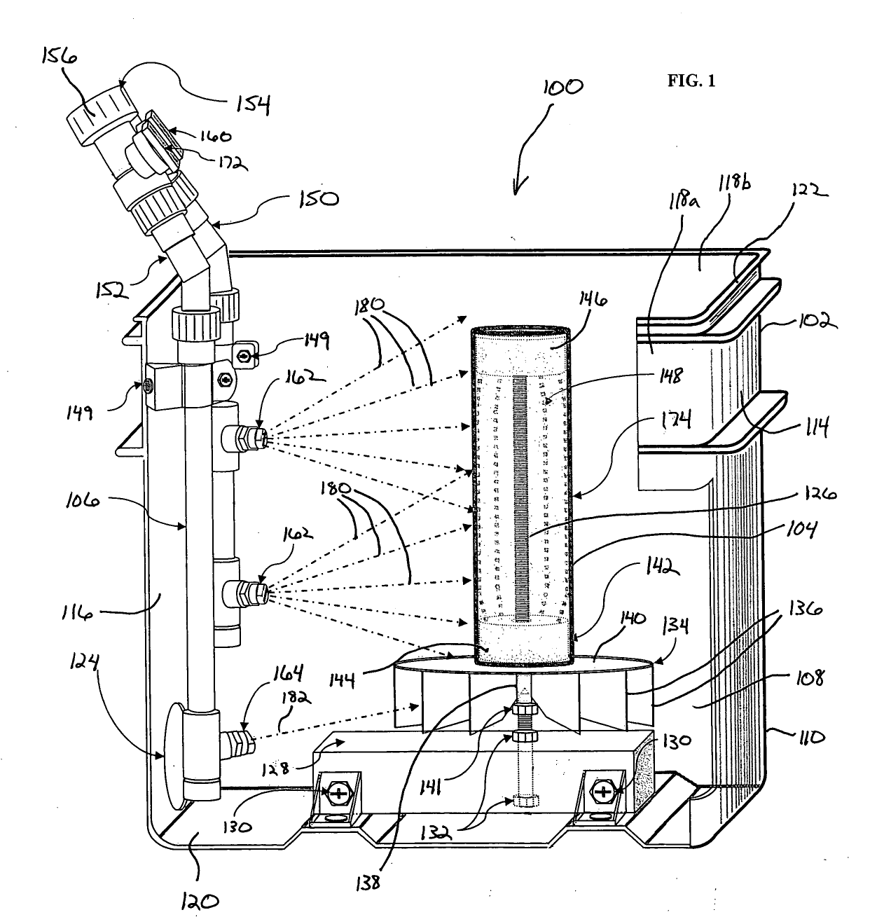

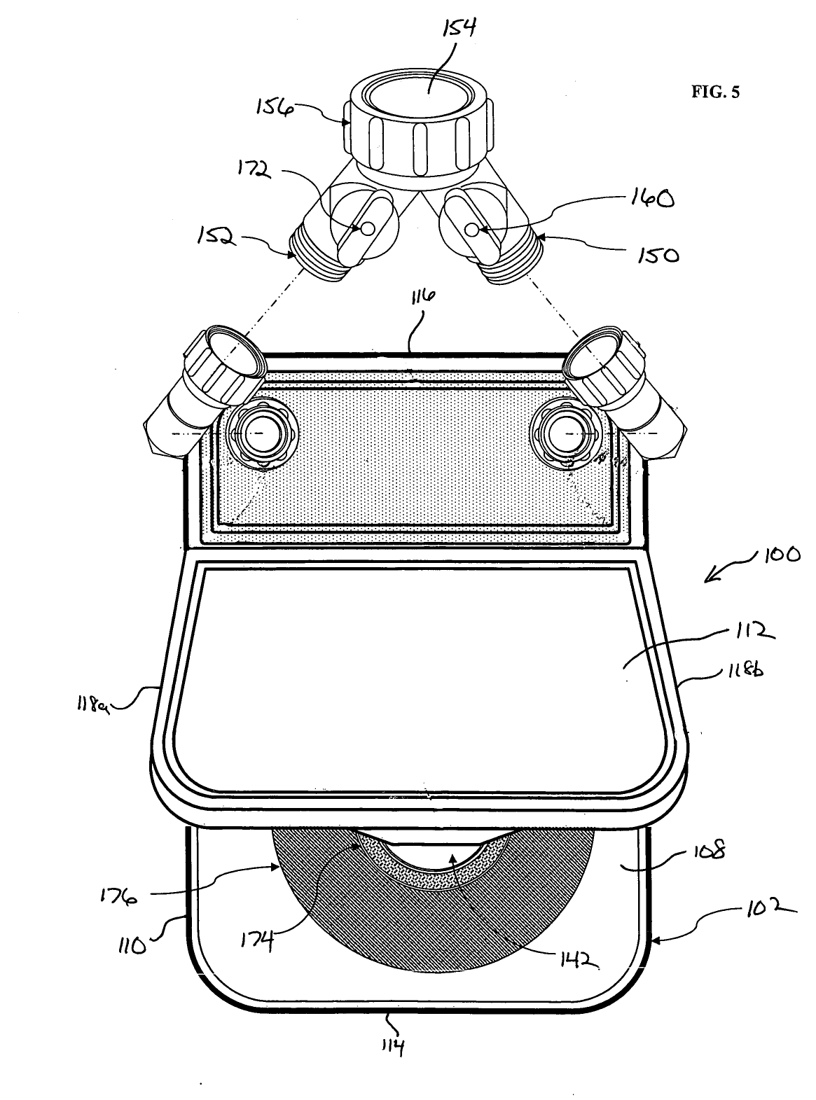

An embodiment of a cleaning assembly 100 for cleaning and drying cylindrical elements is illustrated in FIGS. 1, 1a and 5. The cleaning assembly 100 generally comprises a housing assembly 102, an element mounting assembly 104 for mounting said cylindrical element for cleaning and a water jet assembly 106 for supplying liquid jet sprays within an interior portion 108 of the housing assembly 102.

With reference to FIGS. 1, 1a and 5, housing assembly 102 generally comprises a base portion 110 and a cover 112. Base portion 110 generally comprises a front wall 114, a rear wall 116, a pair of side walls 118a, 118b and a floor 120. Base portion 110 is preferably sized to fit within a typical residential utility sink and can have an interior volume between about 3 gallons to about 13 gallons. Housing assembly 102 can include a handle 121 allowing for easy carrying and placement of the cleaning assembly 100. Cover 112 attaches at a top opening 122 of the base portion 110 to fully enclose the interior portion 108. Cover 112 can attach to base portion 110 in a variety of suitable arrangements such as, for example, a removable lift-off or slide arrangement or alternatively, a hinged arrangement with respect to base portion 110, or other suitable mounting arrangements. When cover 112 is closed over the top opening 122, housing assembly 102 is preferably fully enclosed though cover 112 may be undersized with respect to top opening 122 to partially enclose the housing assembly 102. Base portion 110 and cover 112 can comprise suitable liquid compatible materials such as for example, plastics, metals, wood, Styrofoam®, and other suitable materials. Housing assembly 102 can be manufactured to have any desired exterior shape such as, for example, square, circular, rectangular, and other suitable geometric shapes. Base portion 110 comprises at least one drain port 124 proximate the floor 120. The drain port 124 may include a drain fitting such as, for example, a barbed tube fitting allowing a drain line to be connected to the base portion 110.

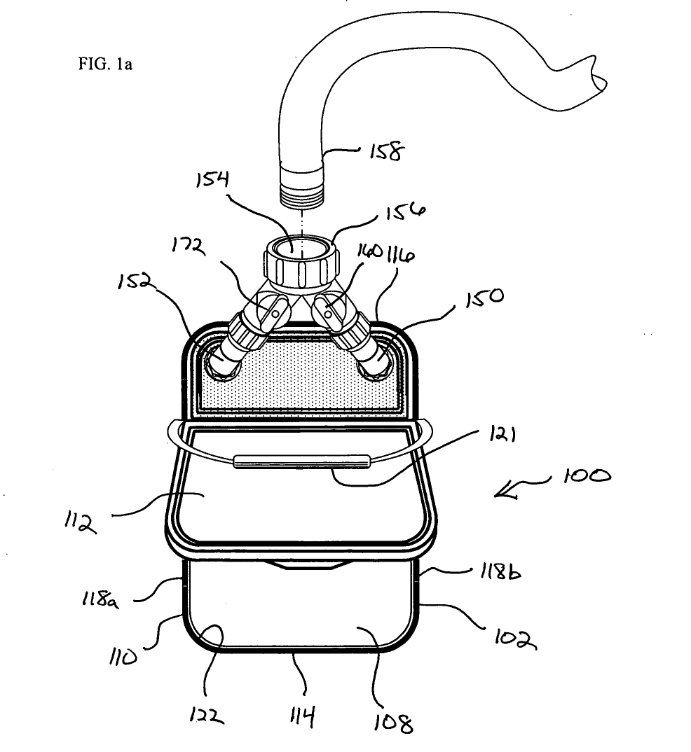

As illustrated in FIGS. 1 and 2, element mounting assembly 104 can comprise a vertical center post 126 projecting through a mounting block 128 attached to floor 120 with brackets 130. Vertical center post 126 can comprise a threaded rod. Vertical center post 126 is fixedly retained in positioned through the mounting block 128 with a pair of threaded securing nuts 132 attached to the vertical center post 126 positioned above and below the mounting block 128. By tightening the threaded securing nuts 132 against the mounting block 128, the vertical center post 126 is held in position and prevented from spinning.

Mounted over the vertical center post 126 and oriented above the mounting block 128 is a paddlewheel assembly 134 having a plurality of downwardly facing turbine blades 136, a paddlewheel hub 138 and an attachment surface 140. The paddlewheel hub 138 has an internal bore sized to have a larger diameter than the diameter of the vertical center post 126 such that the paddlewheel assembly 134 can spin around the vertical center post 126. A spacing nut 141 is positioned below the paddlewheel hub 138 so as to vertically position the turbine blades 136 at a desired height above the mounting block 128.

The vertical center post 126 extends through the paddlewheel hub 138 and the attachment surface 140 such that a roller cage 142 can be placed over the vertical center post 126. In a preferred embodiment, the roller cage 142 substantially resembles a roller cage on a typical paint roller. Roller cage 142 generally comprises a unitary structure having a bottom cap 144, a top cap 146 and a wire frame 148. Bottom cap 144 is joined to the attachment surface 140 such that when the paddlewheel assembly 134 spins around the vertical center post 126, the roller cage 142 spins as well.

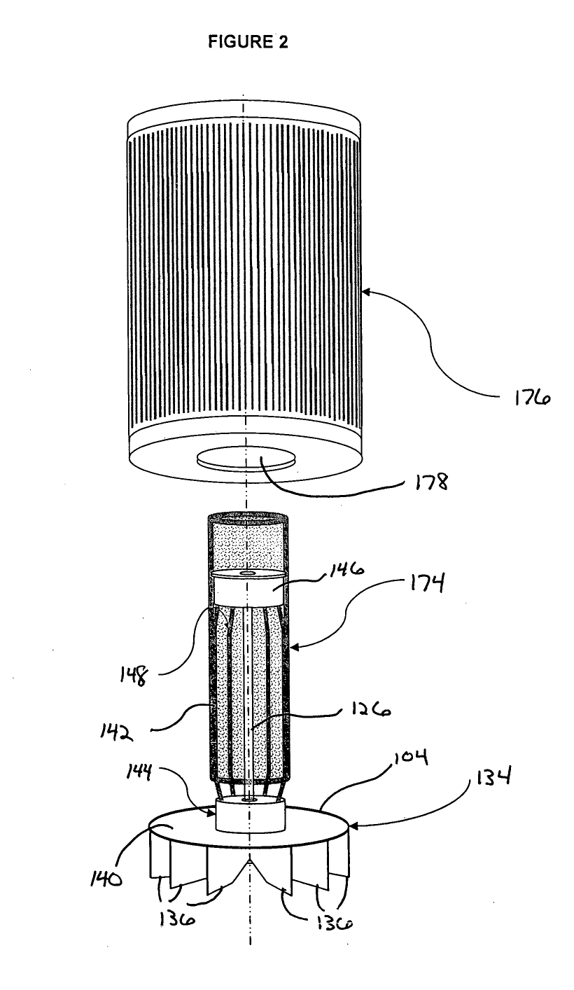

As illustrated in FIGS. 1 and 3, the water jet assembly 106 is fixedly mounted within the interior portion 108 of housing assembly 102 using mounting clips 149. Water jet assembly 106 generally comprises a cleaning flow circuit 150 and a hydraulic energy circuit 154. Cleaning flow circuit 150 and hydraulic energy circuit can be constructed of suitable piping materials, including piping, fittings, connectors and flow components made of PVC, carbon steel, stainless steel and combinations thereof. In a preferred embodiment, cleaning flow circuit 150 and hydraulic energy circuit 152 share a common inlet 154. Inlet 154 can comprise a hose connection 156 for attachment to a utility or garden hose 158 as illustrated in FIG. 1a. Cleaning flow circuit 150 can include a cleaning flow valve 160 and a least one cleaning spray jet 162. Hydraulic energy circuit 152 generally includes at least one hydraulic energy spray jet 164. In some embodiments, cleaning spray jet 162 and hydraulic energy spray jet 164 can comprise manually adjustable spray jets wherein their individual spray patterns can be adjusted based upon inlet flow variables and/or cylindrical element size.

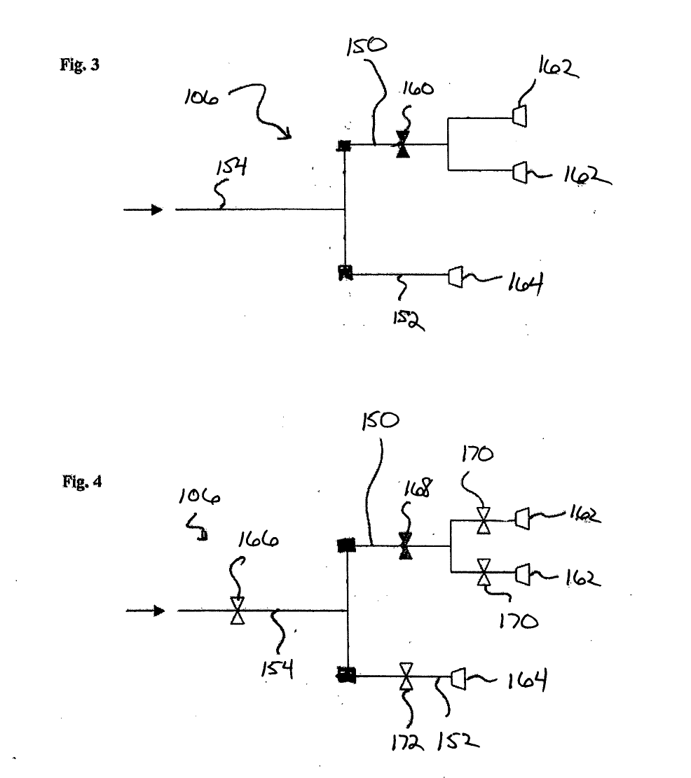

As will be understood by one of ordinary skill in the art, water jet assembly 106 can comprise a variety of alternative flow arrangements including, for example, the embodiment illustrated in FIG. 4 wherein the cleaning flow circuit 150 and hydraulic energy circuit 154 share a common inlet valve 166. Cleaning flow circuit 150 can further include a cleaning supply valve 168 as well as individual cleaning jet supply valves 170 for individually controlling flow through each adjustable cleaning spray jet 162. Similarly, hydraulic energy circuit 154 can include a hydraulic energy supply valve 172. Alternative, cleaning flow circuit 150 can comprise a wash additive reservoir for adding a suitable detergent or cleaner to assist in cleaning the cylindrical element.

In use, cleaning assembly 100 can be utilized to clean a cylindrical element such as, for example, a roller cover 174 or a pool or spa filter 176 as illustrated in FIGS. 1, 2 and 5. Generally a user positions the housing assembly 102 at a suitable location, either indoors or outside, that has a nearby water source and can accommodate drain water. The user connects inlet 154 to a water source such as, for example, from garden hose 158. Next the user opens cover 112 to provide access to the interior portion 108.

In the case of the cylindrical element comprising roller cover 174, the user removes the roller cover 174 from their paint roller and slides the roller cover 174 over the top cap 146 such that the wire frame 148 in within the interior of the roller cover 174. The roller cover 174 is preferably pushed down the wire frame 148 until the bottom cap 144 is within the interior of the roller cover 174. In this way, attachment of the roller cover 174 to the roller cage 142 substantially resembles the typical installation of roller cover 174 on a paint roller and allows roller cage 142 to cleaning roller covers having a variety of different lengths including 3 inch, 4 inch, 7 inch, 9 inch and any other commercially available length. In addition, placement of the roller cover 174 over the roller cage 142 exposes the entire exterior surface of the roller cover 174 to be sprayed and cleaned and prevents clips or connectors such as, for example, those disclosed in U.S. Pat. No. 5,816,275 to Mullen, from covering portions of the exterior surface of the roller cover 174 wherein the roller cover 174 is not fully sprayed and paint can be retained under the clips.

In the case of the cylindrical element comprising pool or spa filter 176, the filter 176 can be similarly positioned over roller cage 142 as describe with respect to roller cover 174. However, due to variations commonly found in pool and spa filter from different manufacturers, an inexpensive roller cover 174 can be used as a filter adapter if a hollow inner core 178 of the filter 176 exceed the diameter of the roller cage 142. To increase the effective diameter of the roller cage 142, the user need only install roller cover 174 having a suitable nap length to increase the effective diameter of the roller cage 142. With the increased effective diameter, the filter 176 can be placed over the roller cover 174 such that the roller cover 174 resides within the inner core 178. In addition, the nap length can be selected to provide an interference style fit within the inner core 178 to tightly retain the filter 176 to the roller cage 142.

After the cylindrical element has been installed, the user can commence a cleaning cycle wherein water flows from inlet 154 through the cleaning flow circuit 150 and the hydraulic energy circuit 152. With respect to cleaning flow circuit 150, either cleaning flow valve 160 or cleaning supply valve 168 and selected cleaning jet supply valve 170 can be opened such that water is directed through one or more of the cleaning spray jets 162. If the hydraulic energy supply valve 172 is present with the hydraulic energy circuit 152, the hydraulic energy supply valve 172 is also opened to allow water to flow through the hydraulic energy spray jet 164. As water flows through the cleaning spray jets 162, one or more cleaning sprays 180 can be formed to fully over spray the length of the cylindrical element. At the same time, a focused hydraulic energy spray 182 is sprayed from the hydraulic energy spray jet 164 and is directed at the turbine blades 136 causing the paddlewheel assembly 134, the roller cage 142 and the cylindrical element to spin around the vertical center post 126 at a high rate of rotation. Through the combination of the cleaning sprays 180 rinsing the cylindrical element and the centrifugal force applied by rotation of the paddlewheel assembly 134, paint, particulate matter and rinse water are essentially flung from the cylindrical element. Once started, the cleaning cycle can continue without user intervention until the cleaning cycle is complete. If desired, the user can open cover 112 so as to view the progress of the cleaning cycle and determine if the cleaning cycle is complete by viewing the condition of the cylindrical element.

When the user determines the cleaning cycle to be complete, the user initiates a drying cycle by closing either the cleaning flow valve 160 or the cleaning supply valve 168 such that cleaning sprays 180 are terminated. At the same time, water continues to flow through the hydraulic energy circuit 152 such that the hydraulic energy spray 182 continues to cause paddlewheel assembly 134 to spin around the vertical center post 126 at a high rate of rotation. This result in any remaining water residing or within the cylindrical element to be flung away from the cylindrical element so as to spin dry the cylindrical element. When the cylindrical element is in the form of roller cover 174, the rotating during the drying cycle promotes drying such that the roller cover 174 dries to a condition wherein the exterior is “puffy” and is substantially the same nap length as a new roller cover. As water accumulates on the floor 120 during both the cleaning and drying cycle, the water flows out of drain port 124 where it can be directed to a drain. Due to the contained nature of cleaning assembly 100, use of cleaning assembly 100 is especially advantageous for indoor use wherein the mess and hassle associated with cleaning cylindrical elements is contained and does not effect the surrounding areas.

Prior to operating the cleaning assembly 100, the user can adjust both the cleaning spray jet 162 and the hydraulic energy spray jet 164 for optimal cleaning and drying. For instance, the user can rotatably turn the cleaning flow circuit 150 and the hydraulic energy circuit 152 within the interior portion 108 to properly align the cleaning spray 180 and the hydraulic energy spray 182. In some embodiments, the cleaning spray jet 162 is manually adjustable allowing a user to increase or decrease the width of the cleaning spray 180 based on the length of the cylindrical element. If the cleaning flow circuit 150 comprises a plurality of cleaning spray jets 162, the individual cleaning sprays 180 can be adjusted to overlap to ensure full spray coverage of the cylindrical element. If the cleaning flow circuit 150 includes individual cleaning jet supply valves 170, the appropriate number of cleaning spray jets 162 can be used by selectively opening and closing the individual cleaning jet supply valves 170. Hydraulic energy spray jet 164 can be adjusted such the hydraulic energy spray 182 is focused solely on the turbine blades 136 so as to achieve maximum rotational speed for the paddlewheel assembly 134.

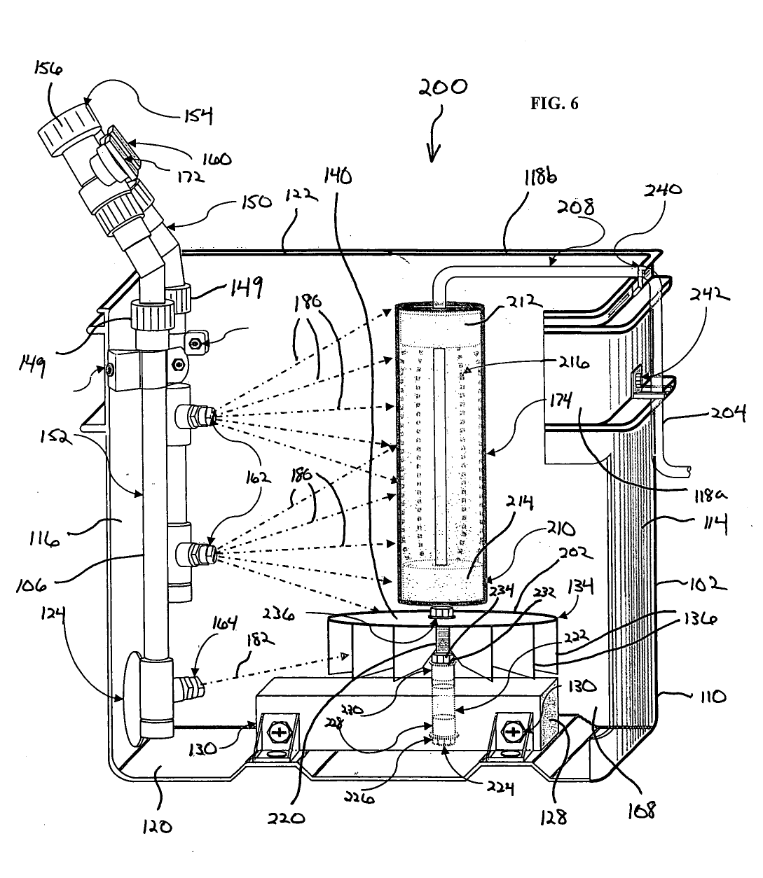

An alternative embodiment of a cleaning assembly 200 is illustrated in FIG. 6. Generally, cleaning assembly 200 can resemble cleaning assembly 100 so as to include housing assembly 102 and water jet assembly 106 with an element mounting assembly 202 adapted to receive roller cover 174 while still attached to a paint roller 204.

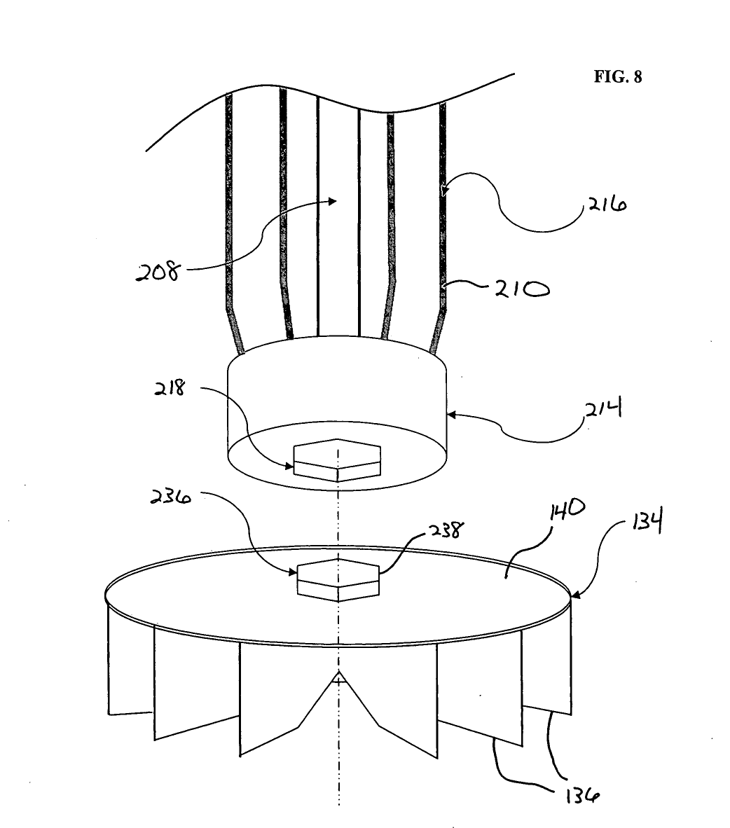

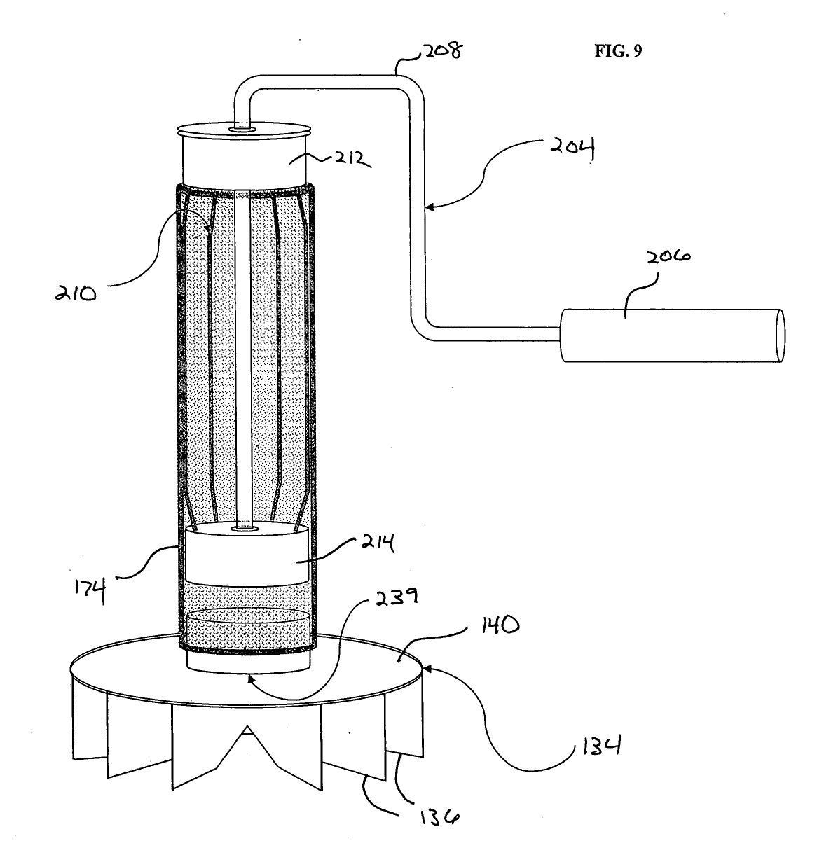

As depicted in FIGS. 6 and 9, paint roller 204 generally comprises a roller handle 206, a roller arm 208, a roller cage 210 and roller cover 174. Roller cage 210 can substantially resemble the construction of roller cage 142 with the exception being that roller cage 210 is not a component of the cleaning assembly 200 such that removal of the paint roller 204 causes removal of the roller cage 210. Roller cage 210 includes a top cap 212, a bottom cap 214 and a wire frame 216. As illustrated in FIG. 8, bottom cap 214 can include a non-circular receiving aperture 218 such as, for example, a triangular, square, pentagonal, hexagonal, oval or star-shaped aperture.

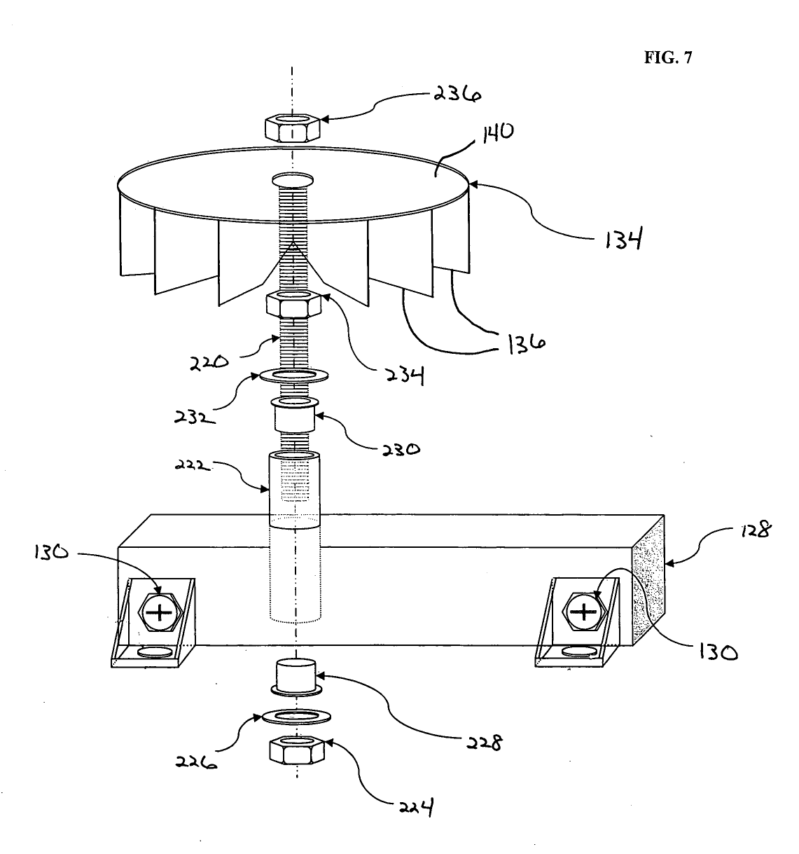

Referring to FIGS. 6 and 7, element mounting assembly 202 can comprise a vertical member 220 projecting through a pressed sleeve 222 in the mounting block 128. Vertical member 220 can comprise a threaded rod. Vertical member 220 is positioned through the pressed sleeve 222 and is stabilized using a bottom nut 224, a bottom washer 226 and a bottom flange bearing 228 below the mounting block 128 and a top flange bearing 230, a top washer 232 and a top nut 234 above the mounting block 128. The vertical member 220 is directed through the paddlewheel hub 138 on paddlewheel assembly 134 and extends through the attachment surface 140 wherein a coupling nut 236 operably joins the vertical member 220 and the paddlewheel assembly 134 such that when the paddlewheel assembly 134 rotates, the vertical member 220 rotates as well. Coupling nut 236 is configured so as to define a projecting perimeter 238 that inserts into and interfaces with the non-circular receiving aperture 218 as illustrated in FIG. 8. Alternatively, the paddlewheel assembly 134 can include a mounting cap 239 fixed to the attachment surface 140 as illustrated in FIG. 9. The mounting cap 239 can substantially resemble the size and shape of the bottom 214 such that a user could partially slide the roller cover 174 off the paint roller 174 and position and place a removed portion of the roller cover 174 over the mounting cap 239 to engage the paint roller 174 with the paddlewheel assembly 134.

In use, cleaning assembly 200 allows roller cover 174 to be cleaned and dried without removing the roller cover 174 from the paint roller 204. A dirty paint roller 204 is generally positioned as shown in FIGS. 6, 8 and 10. The roller arm 208 is positioned to fit within a receiving groove 240 and arm bracket 242 in the base portion 110 as the bottom cap 214 is positioned proximate the attachment surface 140. The bottom cap 214 is oriented such that the coupling nut 236 inserts into the non-circular receiving aperture 218 such that the paddlewheel assembly 134 and the roller cage 210 are operably, rotatably interconnected.

After positioning the paint roller 204, the user can initiate the cleaning and drying cycles as previously described with reference to cleaning assembly 100 such that the cleaning sprays 180 spray the roller cover 174 during the cleaning cycle and the hydraulic energy spray 182 is focused on the turbine blades 136 so as to achieve maximum rotational speed for the paddlewheel assembly 134. As the paddlewheel assembly 134 rotates, the vertical member 220 and coupling nut 236 rotate such that the roller cage 210 and roller cover 174 spin as well. After the cleaning cycle, the cleaning spray 180 can be terminated such that the drying cycle is commenced. Following the drying cycle, the paint roller 204 can be lifted from the receiving groove 240 and the arm bracket 242 wherein the paint roller 204 is ready for immediate use. In some instances, coupling nut 236 and non-circular receiving aperture 218 can be configured in a proprietary manner such that the cleaning assembly 200 can be branded for use with paint roller 204 of a specific brand allowing the cleaning assembly 200 and paint roller 204 to be sold as a branded kit.

When not in use for cleaning cylindrical elements, cleaning assembly 100 and cleaning assembly 200 can be utilized for convenient storage of painting and pool or spa supplies. For instance, a user can place paint rollers, roll covers, brushes, rags, paint trays and liners or pool and spa chemicals or test kits within the interior portion 108 so as to eliminate the mess and clutter associated with said items.

The present disclosure describes aspects of one presently preferred embodiment of a filter cleaning assembly for cleaning and rinsing pool and spa cartridge filters. It will be understood by one of skill in the art that additional, alternative embodiments are contemplated and would not depart from the spirit and scope of the present disclosure.

What is claimed:

1. A hydraulic cleaning assembly for cleaning and drying cylindrical elements comprising:
a housing assembly having a cleaning base and a pivotally attached cover;
an element mounting assembly having a paddlewheel assembly attached to a vertical roller cage; and
a water jet assembly having a distribution manifold mounted on a side wall of the cleaning base, the distribution manifold including a plurality of water jets wherein at least one water jet is positioned to spray a cylindrical element mounted over the vertical roller cage and at least one water jet is positioned to spray the paddlewheel assembly to spin the element mounting assembly around a vertical axis of the element mounting assembly during a cleaning cycle and a drying cycle.

2. The hydraulic cleaning assembly of claim 1, wherein the cylindrical element is selected form the group consisting essentially of: a paint roller cover, a spa filter and a pool filter.

3. The hydraulic cleaning assembly of claim 1, wherein the housing assembly includes a lifting handle providing for handheld carrying of the hydraulic cleaning assembly.

4. The hydraulic cleaning assembly of claim 1, wherein the at least one water jet positioned to spray the paddlewheel is focused at a plurality of turbine blades on the paddlewheel so as to avoid overspray onto the cylindrical element while the element mounting assembly spins around the vertical axis.

5. The hydraulic cleaning assembly of claim 1, wherein the vertical roller cage is releasably attached to the paddlewheel assembly such that a paint roller including the vertical roller cage can be mounted to the paddlewheel assembly for cleaning a roller cover without requiring removal of the roller cover from the paint roller.

6. The hydraulic cleaning assembly of claim 5, wherein the paddlewheel assembly includes a mounting surface having a projecting member configured for insertion into a receiving aperture located on a bottom cap of the paint roller.

7. The hydraulic cleaning assembly of claim 1, wherein the pivotally attached cover provides visible access into an interior portion of the cleaning base allowing inspection of the cylindrical element during the cleaning cycle or the drying cycle.

8. The hydraulic cleaning assembly of claim 1, wherein the distribution manifold comprises a roller cage spray valve and a paddlewheel spray valve wherein both the roller cage spray valve and the paddlewheel spray valve are in an open position during the cleaning cycle and wherein only the paddlewheel spray valve is in an open position during a drying cycle.

9. The hydraulic cleaning assembly of claim 1, wherein each of the plurality of water jets is adjustable to vary the spray from each water jet.

10. The hydraulic cleaning assembly of claim 1, wherein the vertical roller cage is adapted to accept varying cylindrical element sizes including cylindrical elements having an element length selected from the group consisting of: a 3 inch length, a 5 inch length, a 7 inch length and a 9 inch length.

11. A method for hydraulically cleaning cylindrical elements comprising:
mounting a cylindrical element over a roller filter cage;
attaching the roller filter cage to a paddlewheel assembly;
cleaning the cylindrical element by positioning at least two water jets such that at least one water jet spray is directed at the cylindrical element and at least one water jet spray is directed at turbine blades on the paddlewheel assembly; and
drying the cylindrical element by directing at least one water jet spray at the turbine blades and eliminating any water jet spray from hitting the cylindrical element.

12. The method of claim 11, further comprising:
opening a cover assembly to provide viewable access to the cylindrical element during either the cleaning or drying step.

13. The method of claim 11, wherein attaching the roller filter cage to the paddlewheel assembly includes interfacing a filter cage aperture with a projecting member on a mounting surface of the paddlewheel assembly.

14. The method of claim 11, wherein mounting the cylindrical element over the roller filter cage exposes an entire exterior surface of the cylindrical element to water jet spray during the cleaning step.

15. The method of claim 11, wherein the cylindrical element is selected from the group consisting essentially of: a paint roller cover, a pool filter and a spa filter.

16. A hydraulic cleaning assembly for cleaning and drying cylindrical elements comprising:
a housing assembly having means for viewing a cylindrical element during cleaning or drying of the cylindrical element;
an element mounting assembly having a means for vertical mounting the cylindrical element to a paddlewheel assembly, the means for vertical mounting accommodating a plurality of cylindrical element sizes;
a means for spraying the cylindrical element; and
a means for hydraulically spinning the paddlewheel assembly.

17. The hydraulic cleaning assembly of claim 16, wherein the means for viewing comprises a pivoting cover attached to a cleaning body, wherein the pivoting cover can be opened during either a cleaning cycle or a drying cycle.

18. The hydraulic cleaning assembly of claim 16, wherein the means for spraying the cylindrical element comprises at least one water jet.

19. The hydraulic cleaning assembly of claim 16, wherein the mean for hydraulically spinning the paddlewheel assembly comprises at least one water jet focused to spray against a plurality of downwardly facing turbine blades on the paddlewheel assembly.

20. The hydraulic cleaning assembly of claim 16, wherein the means for vertical mounting the cylindrical element to the paddlewheel assembly comprises a filter cage having a filter cage aperture adapted to operably interface with a projecting member on a mounting surface of the paddlewheel assembly.
